(19) United States
(12) Patent Application Publication
(10) Pub. No.: US 2016/0254107 A1
(43) Pub. Date: Sep. 1, 2016

(54) ARC QUENCHING CHAMBER INSERT

(71) Applicant: EATON INDUSTRIES (AUSTRIA) GMBH, Austria (AT)

(72) Inventor: Raffael ZIMMEL, Tulln (AT)

(21) Appl. No.: 15/032,314

(22) PCT Filed: Oct. 29, 2014
(86) PCT No.: PCT/EP2014/073169

§ 371 Date: Apr. 27, 2016

(30) Foreign Application Priority Data
Oct. 29, 2013 (DE) 10 2013 111 902.6

(51) Int. Cl. H01H 33/10

(52) U.S. Cl. CPC H01H 33/10

(57) ABSTRACT

An arc quenching chamber insert for an electrical switching device has a metal plate holder made of an insulating material, and in which a predefinable plurality of metal plates are mounted in the metal plate holder in a predefinable spaced relation to each other. A first end region of the metal plate holder is designed with predefinable contouring, and that a second end region of the metal plate holder at the opposite end from the first end region have mirror-inverted contouring compared with the first end region.

### CROSS-REFERENCE TO RELATED APPLICATIONS

This application is a U.S. national stage application under 35 U.S.C. §371 of International Application No. PCT/EP2014/073169, filed on Oct. 29, 2014, and claims benefit to German Patent Application No. DE 10 2013 111 902.6, filed on Oct. 29, 2013. The International Application was published in German on May 7, 2015, as WO 2015/063120 A1 under PCT Article 21(2).

### FIELD

The invention relates to an arc quenching chamber insert.

### BACKGROUND

Switching devices are known, which, in the event of excessive currents in a power grid lasting for longer than a predefinable time, disconnect this power grid from a supply grid in order to prevent the further supply of electrical current. Switching devices are also known which, in the event of a short circuit in a power grid, disconnect this power grid from a supply grid in order to prevent the further supply of electrical current. Such switching devices therefore have an isolation device, which interacts in particular with an overcurrent release device or a short circuit breaker which actuate the mechanical isolation device when tripped, which device disconnects the switching contacts of the switching device and prevent the further current flow.

When the switching contacts are disconnected, an arc occurs in the process between the switching contacts to be disconnected due to the physical conditions which are described in the law of induction. In the event of a short circuit in a power grid, very large currents in the range of between 5 kA and 25 kA, for example, can occur. Therefore, when the switching device is switched off due to a short circuit, the switching contacts must interrupt a very large electrical current. The arc that occurs in the process is accordingly strong and would lead to destruction of the switching device in the case of a switching device devoid of special equipment. Such switching devices therefore normally have an arc quenching chamber, which conducts the resulting arc and removes energy therefrom until said arc is quenched. For this purpose, the arc quenching chamber has a series of metal plates, which are also described as de-ion plates or quenching plates. In the process, the arc quenching chamber must be adapted to the maximum current strength to be switched through such a switching device. This leads to the quenching chamber having to be dimensioned and produced for each switching device. In addition to this outlay, it has also been proven that the production of quenching chambers having a large number of quenching plates, in particular more than fifteen, is disproportionately complex to produce.

### SUMMARY

An aspect of the invention provides an arc quenching chamber insert for an electrical switching device, the arc quenching chamber insert comprising: a quenching plate holder including an insulating material; and a predefinable number of quenching plates, arranged in the quenching plate holder at a predefinable spacing from one another, wherein a first end region of the quenching plate holder has a predefinable contouring, and wherein a second end region of the quenching plate holder, opposite the first end region, has mirror-inverted contouring compared to the first end region, such that the predefinable contouring of the first end region of a first arc quenching chamber insert is configured to engage in the mirror-inverted contouring of the second end region of a second arc quenching chamber insert.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is an axonometric view of a preferred embodiment of an arc quenching chamber insert according to the invention;

FIG. 2 is a front view of an arc quenching chamber system consisting of two arc quenching chamber inserts according to FIG. 1;

FIG. 3 is an axonometric view of the arc quenching chamber system according to FIG. 2; and

FIG. 4 is a front view of a switching device having an arc quenching chamber system according to FIG. 2.

### DETAILED DESCRIPTION

An aspect of the invention provides an arc quenching chamber insert by means of which the described disadvantages can be prevented and which simply allows for an adaptation of the quenching chamber to a predefined current strength of a switching device, and allows for the formation of a safe and durable quenching chamber.

As a result, an arc quenching chamber insert can be formed, which is simple and cost-effective to produce and allows for a plurality of identical arc quenching chamber inserts to be arranged in a row one behind the other. As a result, an arc quenching chamber in a switching device can be simply adapted to the current strength for which the switching device is or will be designed, in that a larger or smaller number of arc quenching chamber inserts are provided for the switching device concerned. As a result of the present configuration of the arc quenching chamber inserts, in such an arrangement of a plurality of arc quenching chamber inserts one behind the other and in a row, it can be achieved that the spacing between the individual quenching plates, including in the region of the junction between the two arc quenching chamber inserts, is substantially equal and constant. It has been proven that different spacings between the quenching plates lead to overloading of individual quenching plates in certain regions, and can thus lead to a reduction in the service life of the switching device concerned.

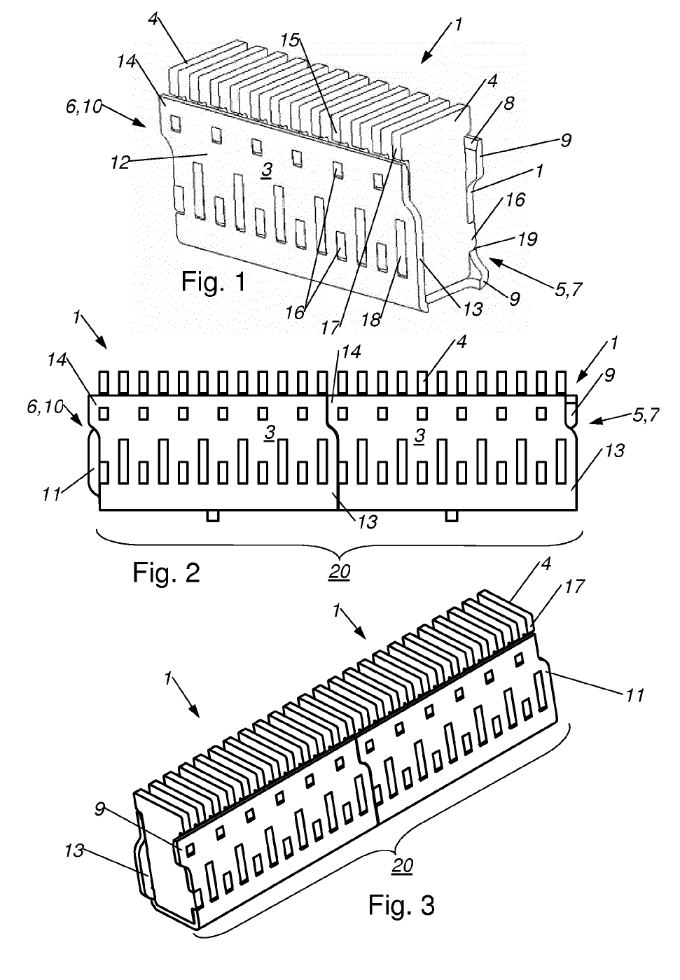

FIGS. 1 to 4 each show at least one arc quenching chamber insert 1 for an electrical switching device 2, the arc quenching chamber insert 1 comprising a quenching plate holder 3 made of insulating material, and a predefinable number of quenching plates 4 being arranged in the quenching plate holder 3 at a predefinable spacing from one another, wherein a first end region 5 of the quenching plate holder 3 is designed having predefinable contouring and a second end region 6 of the quenching plate holder 3 that is opposite the first end region 5 has mirror-inverted contouring compared to the first end region 5.

As a result, an arc quenching chamber insert 1 can be formed which is simple and cost-effective to produce and allows for a plurality of identical arc quenching chamber inserts 1 to be arranged in a row one behind the other. As a result, an arc quenching chamber 26 in a switching device 2 can simply be adapted to the current strength for which the switching device 2 is designed, in that a larger or smaller number of arc quenching chamber inserts 1 is provided for the switching device 2 concerned. As a result of the present configuration of the arc quenching chamber inserts 1, in such an arrangement of a plurality of arc quenching chamber inserts 1 one behind the other and in a row, it can be achieved that the spacing between the individual quenching plates 4, including in the region of the junction between the two arc quenching chamber inserts 1, is substantially equal and constant. It has been proven that different spacings between the quenching plates 4 lead to overloading of individual quenching plates 4, in certain regions, and can thus lead to a reduction in the service life of the switching device 2 concerned.

The arc quenching chamber insert 1 is intended to be arranged in an arc quenching chamber 26 of a switching device 2. This is a region of a switching device 2 which is provided and/or designed to quench an arc that occurs during the course of a switching process in the switching device 2. For this purpose, a plurality of quenching plates 4 are arranged inside the arc quenching chamber 26 according to the present invention. An arc quenching chamber insert 1 is the element or component which supports and holds the quenching plates 4. In the process, the arc quenching chamber insert 1 is preferably designed as a self-supporting structural unit, therefore as a component, which can be preassembled and can be inserted as a whole into a switching device 2.

The arc quenching chamber insert 1 comprises a quenching plate holder 3 made of an insulating material, in which a predefinable number of quenching plates 4 are arranged at a predefinable spacing from one another. The insulating material is preferably a polymer. The quenching plates 4 are designed as sheet metal, in particular steel and copper alloys being preferred. The quenching plates each have a substantially flat basic form.

The quenching plate holder 3 is preferably U-shaped. In this case, the U-shaped quenching plate holder 3 comprises a first leg 8, a second leg 12 and a connecting piece 27 connecting the two legs.

Preferably, at least one quenching plate 4 is arranged in a substantially standard manner on a longitudinal extension of the U-shaped quenching plate holder 3 and thus also substantially in parallel with a first end region 5 and with a first end side 7 of the U-shaped quenching plate holder 3. In this case, the quenching plates 4 are arranged in particular substantially in parallel with one another and are each substantially equally spaced apart, as is also shown in FIGS. 1 to 4.

The individual quenching plates 4 are preferably asymmetrical, it being provided in particular for all of the quenching plates 4 to be substantially identical, but to be arranged in different positions in the quenching plate holder 3 in each case. In this case, it is provided in particular for at least one extension 16 to be arranged on a first lateral surface 15 of the quenching plates 4, and for at least one second extension 18 to be arranged on a second lateral surface 17 of the quenching plates 4. In this case, the first extension 16 has a different arrangement and/or design to the second extension 18. In the case of the preferred embodiment shown, the quenching plates 4 have two first extensions 16 and one second extension 18. In this case, the respective extensions 16, 18 are designed differently in terms of their dimensions as well as in terms of the region in which they are arranged on the lateral surfaces 15, 17 of the quenching plates 4. As a result of the asymmetrical design of the quenching plates 4, the design described in more detail of the arc quenching chamber insert 1 is advantageously supported. The quenching plates 4 are held in corresponding receptacles or holes in the first leg 8 and the second leg 12 of the U-shaped quenching plate holder 3.

It is provided for a first end region 5 of the quenching plate holder 3 to be designed having predefinable contouring and for a second end region 6 of the quenching plate holder 3 that is opposite the first end region 5 to have mirror-inverted contouring compared to the first end region 5. In this case, contouring means in particular that corresponding regions predefinably have at least one protrusion and one corresponding recess. In this case, the contouring of the first end region 5 of a first arc quenching chamber insert 1 is provided, into which mirror-inverted contouring of the second end region 6 of another arc quenching chamber insert 1 engages. In this case, it is provided in particular for the mirror-inverted contouring on the two arc quenching chamber inserts 1 to be constructed such that the two arc quenching chamber inserts 1 can be joined in the most seamless manner possible.

It is preferably provided for at least one first protrusion 9 to be arranged on a first end face 7 of the U-shaped quenching plate holder 3, for at least one second protrusion 11 to be arranged on a second end face10 of the U-shaped quenching plate holder 3 and for the second protrusion 11 to be designed so as to be mirror-inverted compared to the first protrusion 9. In this case, the first protrusion 9 forms the contouring on the first end region 5 and the second protrusion 11 forms the contouring on the second end region 6.

In this case, the relevant first and second protrusion 9, 11 can be arranged at any point on the first and second end face 7, 10, respectively, of the U-shaped quenching plate holder 3. It can also be provided for the relevant first and/or second protrusion 9, 11 to be integrally molded to the side of the quenching plate holder 3.

In this case, the mirror-inverted design of the first and second protrusion 9, 11, which can also be described as extensions, means that, for example, a region is formed spatially next to the first protrusion 9, which region can act as a receptacle for a second protrusion 11 of another arc quenching chamber insert 1. The at least one first protrusion 9 therefore also forms, at least in regions, the boundary of the receptacle or recess for the second protrusion 11 of another arc quenching chamber insert 1.

According to the preferred embodiment shown in FIGS. 1 to 3, it is provided for the first protrusion 9 and the second protrusion 11 to be arranged on a first leg 8 of the U-shaped quenching plate holder 3. In this case, in the preferred embodiment shown in FIGS. 1 to 4, the first protrusion 9 is arranged on a region of the relevant first leg 8 which is facing away from the connecting piece 27, and the second protrusion 11 being arranged on a region of the first leg 8 which is adjacent to the connecting piece 27.

In this case, it is also preferably provided for at least one third protrusion 13 to be arranged on the first end face 7 of a second leg 12 of the U-shaped quenching plate holder 3, for a fourth protrusion 14 to be arranged on the second end face 10 of the second leg 12, for the third protrusion 13 to be designed to correspond to the second protrusion 11 and for the fourth protrusion 14 to be designed to correspond to the first protrusion 9.

FIGS. 2 and 3 each show an arc quenching chamber system 20 consisting of two identical arc quenching chamber inserts 1, the first end region 5 of one arc quenching chamber insert 1 being arranged such that it rests against the second end region 6 of the other arc quenching chamber insert 1. By means of such arc quenching chamber systems 20, the insert for an arc quenching chamber 26 of a switching device 2 can be adapted according to the particular current strength, to be switched, of the switching device 2 concerned by arranging a plurality of arc quenching chamber inserts 1 in a row.

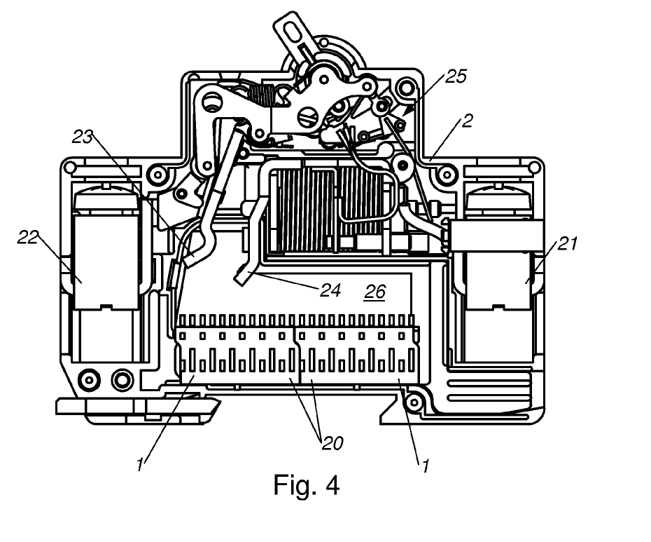

FIG. 4 is a view of a switching device 2 comprising at least one input terminal 21 and at least one output terminal 22 for connecting electrical conductors, and comprising a first switching contact 23 and a second switching contact 24, the switching contacts 23, 24 making a current path between the input terminal 21 and the output terminal 22 when closed, an isolation device 25 for disconnecting the first switching contact 23 and the second switching contact 24 being provided, at least one arc quenching chamber 26 being arranged in the region of the switching contacts 23, 24, an arc quenching chamber system 20 consisting of two arc quenching chamber inserts 1 being arranged in the arc quenching chamber 26. In one embodiment of the switching device according to the invention for lower current strengths, it is provided for just one single arc quenching chamber insert 1 to be arranged in the accordingly smaller quenching chamber 26.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. An arc quenching chamber insert for an electrical switching device, the arc quenching chamber insert comprising
a quenching plate holder including an insulating material; and
a predefinable number of quenching plates, arranged in the quenching plate holder at a predefinable spacing from one another,
wherein a first end region of the quenching plate holder has a predefinable contouring, and
wherein a second end region of the quenching plate holder, opposite the first end region, has minor-inverted contouring compared to the first end region, such that the predefinable contouring of the first end region of a first arc quenching chamber insert is configured to engage in the mirror-inverted contouring of the second end region of a second arc quenching chamber insert.

2. The insert of claim 1, wherein the quenching plate holder is U-shaped.

3. The insert of claim 2, wherein at least one quenching plate is arranged in a substantially standard manner on a longitudinal extension of the U-shaped quenching plate holder.

4. The insert of claim 2, wherein a first protrusion is arranged on a first end face of the U-shaped quenching plate holder,
wherein a second protrusion is arranged on a second end face of the U-shaped quenching plate holder, and
wherein the second protrusion is configured to be mirror-inverted compared to the first protrusion.

5. The insert of claim 4, wherein the first protrusion and the second protrusion are arranged on a first leg of the U-shaped quenching plate holder.

6. The insert of claim 5, wherein a third protrusion is arranged on the first end face of a second leg of the U-shaped quenching plate holder,
wherein a fourth protrusion is arranged on the second end face of the second leg,
wherein the third protrusion is configured to correspond to the second protrusion, and
wherein the fourth protrusion is configured to correspond to the first protrusion.

7. The insert of claim 1, wherein a first extension is arranged on a first lateral surface of the quenching plates,
wherein a second extension is arranged on a second lateral surface of the quenching plates, and
wherein the first extension has a different design and/or arrangement from the second extension.

8. The insert of claim 6, wherein the quenching plates are held in receptacles in the first leg and the second leg of the U-shaped quenching plate holder.

9. An arc quenching chamber system, comprising:
a first and a second identical arc quenching chamber insert of claim 1,
wherein the first end region of the first arc quenching chamber insert is arranged such that it rests against the second end region of the second arc quenching chamber insert.

10. A switching device, comprising:
an input terminal configured to connect electrical conductors;
an output terminal configured to connect electrical conductors,
a first switching contact;
a second switching contact;
an isolation device configured to disconnect the first switching contact and the second switching contact;
an arc quenching chamber arranged in the region of the first and second switching contacts; and
the arc quenching chamber insert of claim 1,
wherein the switching contacts make a current path between the input terminal and the output terminal when closed,
wherein the arc quenching chamber insert is arranged in the arc quenching chamber.

11. The insert of claim 1, wherein the quenching plate holder is made of an insulating material.

12. The insert of claim 3, wherein the quenching plates are arranged substantially in parallel with one another.

13. A switching device, comprising:
an input terminal configured to connect electrical conductors;
an output terminal configured to connect electrical conductors,
a first switching contact;
a second switching contact;
an isolation device configured to disconnect the first switching contact and the second switching contact;
an arc quenching chamber, arranged in the region of the first and second switching contacts; and
the arc quenching chamber system of claim 9,
wherein the switching contacts make a current path between the input terminal and the output terminal when closed,
wherein the arc quenching chamber system is arranged in the arc quenching chamber.
